(19) United States
(12) Patent Application Publication
(10) Pub. No.: US 2026/0370928 A1
(43) Pub. Date: Nov. 19, 2026

(54) INSPECTION TOOL WITH COMPUTER VISION

(71) Applicant: Milwaukee Electric Tool Corporation, Brookfield, WI (US)

(72) Inventors: Nikita Bhatt, Milwaukee, WI (US); Douglas R. Fieldbinder, Greendale, WI (US)

(21) Appl. No.: 19/144,074

(22) PCT Filed: Dec. 28, 2023
(86) PCT No.: PCT/US2023/086279

§ 371 Date: Jun. 27, 2025

Related U.S. Application Data
(60) Provisional application No. 63/477,468, filed on Dec. 28, 2022.

(51) Int. Cl. H04N 23/50; G06T 7/00; G06V 10/10; G06V 10/764; G06V 10/82; G06V 20/50; H04N 23/53

(52) U.S. Cl. CPC H04N 23/555; G06T 7/0002; G06V 10/17; G06V 10/764; G06V 10/82; G06V 20/50; H04N 23/53; G06T 2207/20081; G06T 2207/20084

(57) ABSTRACT

An inspection camera system that includes an inspection camera tool (e.g., a pipeline inspection tool, a handheld inspection camera tool) having a cable configured to be directed into an interior space (e.g., a pipe, a conduit), where a camera disposed on a distal end of the cable is operable to capture an image. An electronic processor in communication with the camera receives the image from the camera, accesses a machine learning model that has been trained on training data to generate classified feature data from an input image, applies the image to the machine learning model to generate classified feature data that indicate a classification of an object depicted in the image, and displays the image and the classified feature data a user.

### CROSS-REFERENCE TO RELATED APPLICATIONS

This application claims the benefit of U.S. Provisional Patent Application Ser. No. 63/477,468, filed on Dec. 28, 2022, and entitled “INSPECTION TOOL WITH COMPUTER VISION,” which is herein incorporated by reference in its entirety.

### BACKGROUND

Tradesmen have a need to be able to inspect crevices, pipes or hard to reach areas. Inspection tools give users the ability to look inside air ducts, pipes, or crevices that would be otherwise inaccessible. Since a lot of the areas being inspected are difficult to access and view with the naked eye, the inspection camera renders an image that helps users visualize the interiors of the target area.

Pipeline inspection devices can be used to determine the location of obstructions in underground pipes or find damaged areas that affect the integrity of pipe systems. Generally, a pipeline inspection device includes a cable that can be pushed down a length of the pipe. The end of the cable may include an imaging device, such as a video camera, to help identify an obstruction or damage within the pipe. The end of the cable may also include a location device, such as a sonde, to transmit the location of the end of the cable.

### SUMMARY OF THE DISCLOSURE

The present disclosure addresses the aforementioned drawbacks by providing an inspection camera system that includes a cable configured to be directed into an interior space, a camera disposed on a distal end of the cable and operable to capture an image, and an electronic processor in communication with the camera. The electronic processor is configured to: receive the image from the camera; access a machine learning model that has been trained on training data to generate classified feature data from an input image; apply the image to the machine learning model to generate classified feature data that indicate a classification of an object depicted in the image; and display the image and the classified feature data a user.

It is another aspect of the present disclosure to provide a non-transitory computer-readable storage medium storing instructions thereon that, when executed by one or more processors of an electronic device, cause the one or more processors to perform operations that include receiving an image captured with a camera of an inspection camera tool; accessing a machine learning model stored in a memory of the electronic device; inputting the image to the machine learning model to generate an output as classified feature data that indicate a classification the image; and displaying the image and the classified feature data on a display screen.

It is yet another aspect of the present disclosure to provide a method for processing an image captured with an inspection camera tool. The method includes capturing an image of an environment using a camera communicatively coupled to a camera inspection tool, where the environment includes an interior space accessed by the camera inspection tool. The image is received by an electronic processor, and the image is applied to a machine learning controller using the electronic processor. The machine learning controller implements a computer vision model, generating as an output classified feature data indicating a classification of the image. The classified feature data are received from the machine learning controller by the electronic processor, and the image and the classified feature data are displayed to a user via a display screen communicatively coupled to the electronic processor.

### BRIEF DESCRIPTION OF THE DRAWINGS

FIG. 1 is a block diagram of an example inspection camera system having an inspection camera tool that captures images or video of an interior space (e.g., a pipe, a conduit) and is configured to process the images or video using a computer vision model to generate classified feature data that indicate a classification of an object depicted in the images or video.

FIG. 2 illustrates a pipeline inspection tool that can be implemented as the inspection camera tool of the inspection camera system of FIG. 1.

FIG. 3 illustrates a handheld inspection camera tool that can be implemented as the inspection camera tool of the inspection camera system of FIG. 1.

FIG. 4 is a block diagram of an example inspection camera system in accordance with some examples described in the present disclosure, in which the inspection camera tool includes a pipeline inspection tool.

FIG. 5 is a block diagram of an example inspection camera system in accordance with some examples described in the present disclosure, in which the inspection camera tool includes a handheld inspection camera tool.

FIG. 6 is a flowchart illustrating the steps of an example method for processing an image captured with an inspection camera tool using a computer vision model to generate classified feature data that indicate a classification of an object depicted in the image.

FIG. 7 is an example image captured with an inspection camera tool having classified feature data overlaid thereon.

FIG. 8 is a flowchart illustrating the steps of an example method for training a computer vision model to generate classified feature data that indicate a classification of an object depicted in an image captured by an inspection camera tool.

### DETAILED DESCRIPTION

Described here are inspection camera tools that can be used to view the interior of a pipe, conduit, or other interior space not easily accessible or viewable by a user. For example, an inspection camera tool can be used to view the interior of a pipe or conduit, such as a buried sewer pipeline, to locate obstructions, blockages, and/or defects in the pipe.

Advantageously, the inspection camera tools described in the present disclosure utilize computer vision (e.g., implemented using neural networks or other machine learning models) to detect, categorize, and/or classify obstructions, blockages, and/or defects depicted in images captured by the inspection camera tool. The classified features identified in the images can be annotated and displayed to the user, thereby allowing for rapid identification of the obstructions, blockages, and/or defects viewed by the inspection camera tool.

Computer vision uses trained machine learning models (e.g., neural networks or other machine learning models) to determine the nature of objects in an image or video. Utilizing a computer vision algorithm to process images captured by the camera of an inspection camera tool allows users to receive additional information about what they are remotely viewing with the inspection camera tool. This additional insight is advantageous because it can often be difficult to conclusively determine the nature of what is being viewed while utilizing an inspection camera tool either due to poor lighting or lack of user confidence. Computer vision algorithms can advantageously aid the user's decision-making process, thereby enhancing the user experience when using an inspection camera tool.

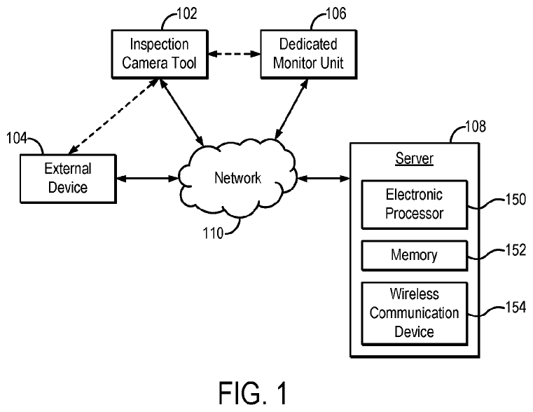

FIG. 1 illustrates an example inspection camera system 100. In the illustrated example, the inspection camera system 100 includes an inspection camera tool 102 and can also include one or more of an external device 104, a dedicated monitor unit 106, a server 108, and a network 110. The inspection camera system 100 may include more or fewer components than those illustrated in FIG. 1 and may perform functions other than those described herein.

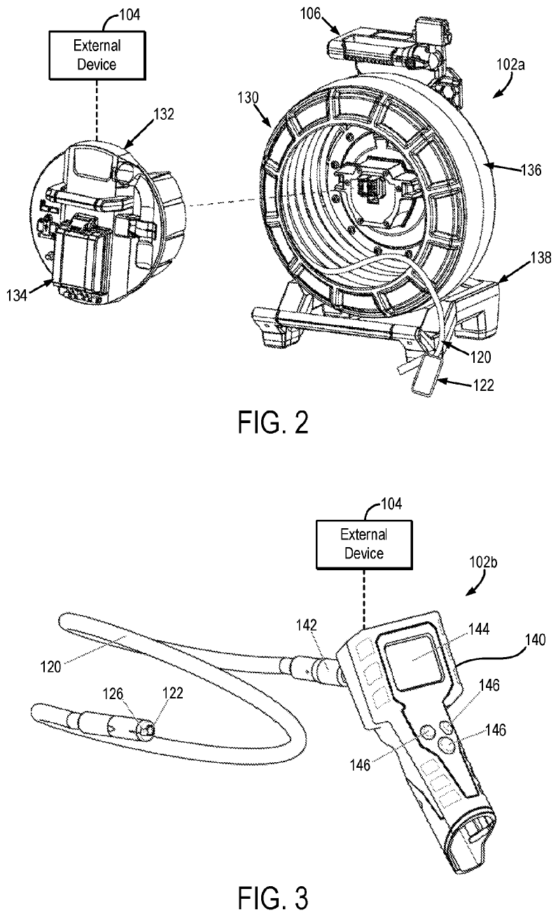

In general, a user can use the inspection camera tool 102 to observe the interior of a pipe (e.g., often from a distance away from the closest access port to the pipeline), a conduit, or other interior space not easily accessible to or viewable by the user. As shown in FIGS. 2 and 3, the inspection camera tool 102 generally includes a cable 120 that is directed into the interior space (e.g., down an access port of a pipe and through the pipeline). The cable 120 includes an image capturing device (e.g., a camera 122). In some examples, the cable 120 may also include a locator device 124 coupled to a distal end of the cable 120. The locator device 124 can help locate the end of the cable 120 at the location of the camera 122. Additionally or alternatively, the camera 120 may include a signal generating device (e.g., a sonde) that emits a point source electromagnetic field that can be detected with a locating device by the user above ground. The locator device 124 may in some other examples include an oscillator, transmitter, and antenna housed within the camera 120.

The camera 122 records images and/or video of the interior of the pipe, conduit, or other interior space into which the cable 120 has been directed and displays the images to the user using the external device 104, the dedicated monitor unit 106, a display screen on the inspection camera tool 102, or the like. The camera 122 may include a light source 126, such as a light emitting diode (“LED”) for illuminating the environment around the camera 122 (i.e., the interior of a pipe, conduit, or other space into which the cable 120 has been directed).

A machine learning controller 170 implemented on the inspection camera tool 102, the external device 104, the dedicated monitor unit 106, a server 108, and/or another connected computing device, can process the images and/or video to generate classified feature data that indicate a classification and/or categorization of one or more regions in the images and/or video, as will be described below in more detail.

As shown in FIG. 2, the inspection camera tool 102 may include a pipeline inspection tool 102a. In such an example, the pipeline inspection tool 102a includes a reel 130 for housing the cable 120 and a control hub 132 for housing a power source 134 (e.g., a battery pack) and other electronic components for operating the pipeline inspection tool 102a and processing images and/or video captured by the camera 122. The cable 120 is stored on the reel 130 in a wound configuration, but can be unwound and threaded through a length of a pipe, conduit, or other interior space under inspection. The control hub 132 provides power to the components of the reel 130 in order to operate the pipeline inspection tool 102a. The control hub 132 can be removably coupled to the reel 130. In some example, the control hub 132 can be interchangeably used with two or more different pipeline inspection tools 102a (e.g., by removably coupling the control hub 132 to the reels 130 of the different pipeline inspection tools 102a). The reel 130 may include a drum 136 supported by a stand 138, which enables rotation of the drum 136 to feed and/or retract the cable 120 when in use.

Additionally or alternatively, as shown in FIG. 3, the inspection camera tool 102 may include a handheld inspection camera tool 102b, such as a borescope. In such an example, the cable 120 can be coupled (e.g., removably coupled) to a housing 140 of the handheld inspection camera tool 102b, such as via a socket sleeve 142. A display 144 is also integrated into the housing 140 of the handheld inspection camera tool 102b. The display 144 can display images and/or video captured by the camera 122, and also classified feature data generated by the machine learning controller 170, as described below in more detail. The housing 140 can also include user interface elements 146 that enable a user to interact with and control operation of the handheld inspection camera tool 102b. For instance, the user interface elements 146 may include buttons that control a zoom of the camera 122, control a brightness of the light source 126, and/or power on/off the handheld inspection camera tool 102b.

Referring again to FIG. 1, in the illustrated example, the inspection camera tool 102 communicates with the external device 104. The external device 104 may include, for example, a smartphone, a tablet computer, a cellular phone, a laptop computer, a smart watch, and the like. The inspection camera tool 102 communicates with the external device 104, for example, to transmit images and/or video captured with a camera of the inspection camera tool 102; classified feature data generated from such images and/or video, or other usage information or power tool device data acquired or generated by the inspection camera tool 102. In some examples, the external device 104 may include a short-range transceiver to communicate with the inspection camera tool 102, and a long-range transceiver to communicate with the server 108. In the illustrated example, inspection camera tool 102 can also include a transceiver to communicate with the external device 104 via, for example, a short-range communication protocol such as Bluetooth® or Wi-Fi®). In some examples, the external device 104 bridges the communication between the inspection camera tool 102 and the server 108. For example, the inspection camera tool 102 may transmit data to the external device 104, and the external device 104 may forward the data from the inspection camera tool 102 to the server 108 over the network 110.

In some examples, the inspection camera tool 102 can act as a node in a mesh network. The mesh network may involve other power tool devices (such as other inspection camera systems, battery packs, power tool battery chargers, power tools, external devices, hubs, etc.). In some other examples, the inspection camera tool 102 may not have any communication with the external device 104 and/or server 108. In these instances, the inspection camera tool 102 can process input received by user interaction with the inspection camera tool 102 (e.g., via one or more user interface elements on the housing of the inspection camera tool 102), by voice command, and so on, to process images and/or video, to display images, video, and/or classified feature data, and the like.

The dedicated monitor unit 106 that can be removably coupled to the inspection camera tool 102. For example, the dedicated monitor unit 106 can be removably coupled to the reel 130 of the pipeline inspection tool 102a shown in FIG. 2 via a monitor mount. As one non-limiting example, the monitor mount can include an insert member that can be removably received within a complementary receptacle of the dedicated monitor unit 106. In such instances, the dedicated monitor unit 106 can be selectively coupled to the monitor mount by sliding the dedicated monitor unit 106 onto the insert member.

The dedicated monitor unit 106 includes a display 644 for showing images (e.g., both pictures and videos) captured by the camera 122 of the inspection camera tool 102, as well as classified feature data that are generated by the machine learning controller 170.

The dedicated monitor unit 106 can include features to help make it more versatile in how it is used. For example, in addition to being removably coupled to the inspection tool 102, the dedicated monitor unit 106 can be carried around a worksite by a user or rested on other surfaces. As one example, the dedicated monitor unit 106 can include one or more handgrips to facilitate carrying the dedicated monitor unit 106 when not coupled to the inspection camera tool 102. The dedicated monitor unit 106 can also include a stand on its back side to support the dedicated monitor unit 106 on other surfaces around the worksite. The stand extends from the back side of the dedicated monitor unit 106 at an angle so that the dedicated monitor unit 106 is supported on a surface at a comfortable viewing angle.

In some examples, the dedicated monitor unit 106 includes a wireless communication device. The dedicated monitor unit 106 can communicate wirelessly with the inspection camera tool 102, the external device 104, and/or the server 108 to receive images captured by the camera of the inspection camera tool 102, classified feature data generated by the machine learning controller 170, or both. In some examples, the dedicated monitor unit 106 may include a battery pack for powering the dedicated monitor unit 106. Additionally or alternatively, the dedicated monitor unit 106 can be powered by inspection camera tool 102 when the dedicated monitor unit 106 is coupled to the inspection camera tool 102. For example, the dedicated monitor unit 106 may be plugged into a control hub 132 of the pipeline inspection tool 102a shown in FIG. 2 to receive power from the power source 134 (e.g., battery pack) housed within the control hub 132.

In general, the external device 104 is a different computing device from the dedicated monitor unit 106, and can be used for other purposes apart from the inspection camera tool 102.

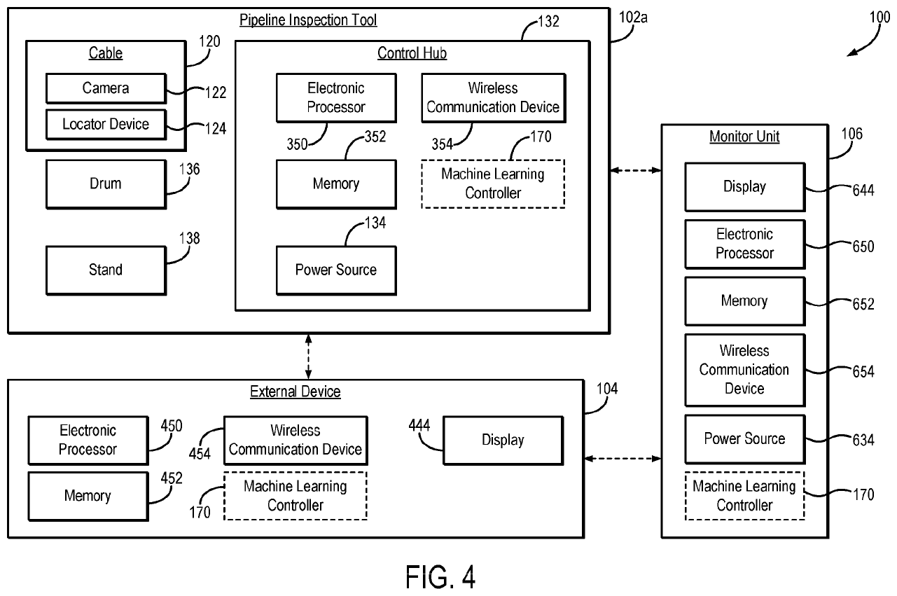

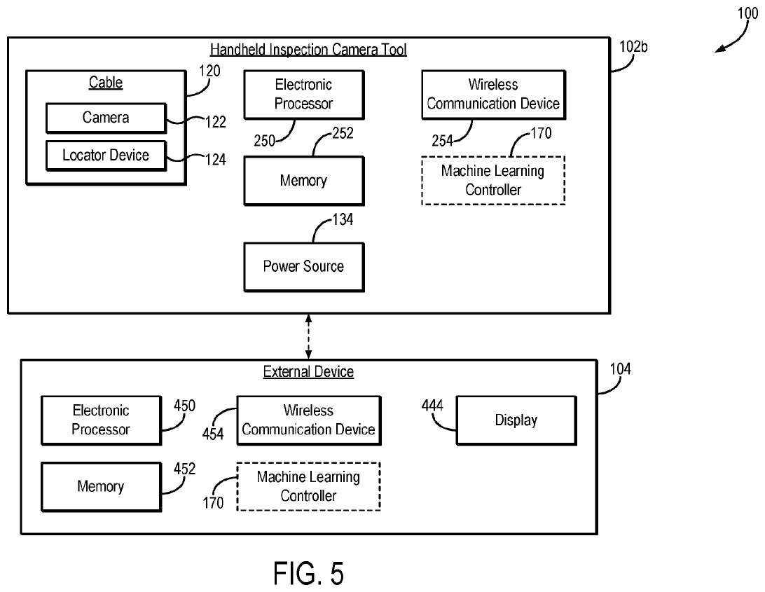

The server 108 includes a server electronic control assembly having a server electronic processor 150, a server memory 152, and a wireless communication device 154. The wireless communication device 154 allows the server 108 to communicate with inspection camera tool 102, the external device 104, and/or the dedicated monitor unit 106. The server electronic processor 150 receives data (e.g., images, video, classified feature data) from the inspection camera tool 102 and stores the received data and/or other usage information or power tool device data in the server memory 152. The server 108 may maintain a database (e.g., on the server memory 152) for containing images, video, classified feature data, power tool device data, trained machine learning controls (e.g., trained machine learning model and/or algorithms), artificial intelligence controls (e.g., rules and/or other control logic implemented in an artificial intelligence model and/or algorithm), and the like. In some embodiments, the server electronic processor 150 can use the received images, usage data, and/or other power tool device data for constructing, training, adjusting, or executing a machine learning controller (e.g., machine learning controller 170 shown in FIGS. 4 and 5). That is, the machine learning controller may be software or a set of instructions executed by the server processor 150 to implement the functionality of the machine learning controller 170 described herein. In some examples, the machine learning controller 170 includes a separate processor and memory to execute the software or instructions to implement the functionality of the machine learning controller 170 described herein.

Although illustrated as a single device, the server 108 may be a distributed device in which the server electronic processor and server memory are distributed among two or more units that are communicatively coupled (e.g., via the network 110).

The network 110 may be a long-range wireless network such as the Internet, a local area network (“LAN”), a wide area network (“WAN”), or a combination thereof. In other embodiments, the network 110 may be a short-range wireless communication network, and in yet other embodiments, the network 110 may be a wired network using, for example, universal serial bus (“USB”) cables. Additionally or alternatively, the network 110 may include a combination of long-range, short-range, and/or wired connections. In some embodiments, the network 110 may include both wired and wireless devices and connections. Similarly, the server 108 may transmit information to the external device 104 to be forwarded to the inspection camera tool 102.

In some example, the inspection camera tool 102 communicates directly with the external device 104 and/or the dedicated monitor unity 106. For example, the inspection camera tool 102 can transmit data (e.g., images and/or video captured with a camera of the inspection camera tool 102) and settings to the external device 104 and/or the dedicated monitor unit 106. Similarly, the inspection camera tool 102 can receive data (e.g., settings, firmware updates, etc.) from the external device 104.

In some other examples, the inspection camera tool 102 bypasses the external device 104 to access the network 110 and communicate with the server 108 via the network 110. In some examples, the inspection camera tool 102 is equipped with a long-range transceiver instead of or in addition to a short-range transceiver. In such instances, the inspection camera tool 102 communicates directly with the server 108 or with the server 108 via the network 110 (in either case, bypassing the external device 104). In some examples, the inspection camera tool 102 may communicate directly with both the server 108 and the external device 104. In such instances, the external device 104 may, for example, generate a graphical user interface to facilitate control and programming of the inspection camera tool 102; processing of images and/or video captured by a camera of the inspection camera tool 102 to generate classified feature data; display images, video, and/or classified feature data; and so on. The server 108 may store and analyze larger amounts of operational data for future programming or operation of the inspection camera tool 102, or may store images, video, and/or classified feature data received from the inspection camera tool 102. In other examples, however, the inspection camera tool 102 may communicate directly with the server 108 without utilizing a short-range communication protocol with the external device 104.

FIG. 4 shows a block diagram of an example inspection camera system 100, in which the inspection camera tool 102 includes a pipeline inspection tool 102a, such as the one shown in FIG. 2. The inspection camera system 100 includes the pipeline inspection tool 102a and optionally an external device 104 and/or dedicated monitor unit 106. The pipeline inspection tool 102a includes a cable 120 to which a camera 122 is coupled, a control hub 132, and a drum 136 and stand 138 for storing, feeding, and retracting the cable 120. As described above, the drum 136 may be a rotatable drum to facilitate feeding and retracting the cable 120.

The electrical and mechanical components of the pipeline inspection tool 102a can be arranged in different manners, some including wired connections and some including wireless connections. Examples of a wired connection and a wireless connection are provided below. However, in other embodiments, some components communicate wirelessly while others include a direct wired connection.

As shown in FIG. 2, the pipeline inspection tool 102a includes a cable 120 and a camera 122 that is coupled to the distal end of the cable 120. As described above, in some examples the cable 120 may also include a locator device 124 coupled to the cable 120 and/or integrated with the camera 122. In some examples, the cable 120 includes both power and data cables that connect (e.g., electrically connect) the camera 122 to the control hub 132. In these instances, the cable 120 provides power to the camera 122 (e.g., by providing power from the power source 134) and provides data signals (e.g., transmitting images and/or video captured by the camera 122) from the camera 122 to the control hub 132. In some examples, the cable 120 can be electrically coupled to the control hub 132 by a slip ring connection to allow for the transmission of electrical signals between the cable 120 and the control hub 132 and power source 134 while allowing the drum 136 to rotate relative to the reel 130.

In operation, the camera 122 and the cable 120 are fed into a pipe, conduit, or other interior space by a user. The camera 122 is snaked or otherwise directed to the area-of-interest (e.g., obstruction, blockage, etc.) while the camera 122 sends data signals (e.g., images, video) to the control hub 132, where the images and/or video may be processed (e.g., processed by the electronic processor 350, processed by the machine learning controller 170) and/or transmitted to the external device 104, dedicated monitor unit 106, or both, for processing (e.g., by electronic processor(s) 450, 650; by a machine learning controller 170 local to the external device 104 or dedicated monitor unit 106).

As described, in some examples, the camera 122 is configured to capture an image (e.g., a single image) and/or video (e.g., a series of images) of the inside of the pipe, conduit, or other interior space to which the camera 122 has been delivered. The external device 104 and/or dedicated monitor unit 106 can receive the captured image or video and display the image or video on the respective display 444, 644 for viewing by a user. Additionally, classified feature data may be generated by processing the image or video with the machine learning controller 170, and the classified feature data may be received by the external device 104 and/or dedicated monitor unit 106 and can be displayed on the respective display 444, 644 for viewing by the user.

For example, the user may view the image to attempt to identify damage to the pipe, conduit, or interior space; or to identify an obstruction or blockage in the pipe, conduit, or interior space. However, in many instances the damage, obstruction, or blockage may not be readily identifiable by the user. Advantageously, the image or video can be processed with the machine learning controller 170 to generate classified feature data that indicate an identified class or category of regions-of-interest in the image or video. For instance, the classified feature data may include labels or annotations of the image or video, which indicate regions of the image or video corresponding to different identified classifications or categories of materials or objects.

Accordingly, it may be beneficial to display the classified feature data together with the image or video. As described above, in some examples, the advantageous display of images captured by the camera 122 together with the corresponding classified feature data generated from those images is provided. In these instances, the interpretation of images displayed to the user is improved, thereby allowing for an improved user experience.

The control hub 132 can include an electronic processor 350, a memory 352, a wireless communication device 354, a power source 134, and optionally a machine learning controller 170. The electronic processor 350, the memory 352, the wireless communication device 354, and the machine learning controller 170 can communicate over one or more control buses, data buses, etc., for the interconnection between and communication among the various modules, circuits, and components in the control hub 132.

The control hub 132 can receive images captured by the camera 122 and send them to the dedicated monitor unit 106 (e.g., via the wireless communication device 354) to show the images on the display 644 of the dedicated monitor unit 106 for a user to view. Additionally or alternatively, the control hub 132 send the images to the external device 104 (e.g., via the wireless communication device 354) to show the images on the display 444 of the external device 104 for a user to view. In some examples, the control hub 132 can generate classified feature data (e.g., by sending the images to a machine learning controller 170 of the control hub 132 using the electronic processor 350 where the images are processed by the machine learning controller 170 to generate the classified feature data) and send them to the external device 104 and/or dedicated monitor unit 106 to show on the respective display 444, 644 for the user to view. In some embodiments, the images may be displayed concurrently with the classified feature data (e.g., by overlaying the classified feature data on the images). In other examples, the images received by the external device 104 and/or dedicated monitor unit 106 from the control hub 132 can be processed to generate classified feature data on the external device 104 (e.g., via a machine learning controller 170 of the external device 104) or the dedicated monitor unit 106 (e.g., via a machine learning controller 170 of the dedicated monitor unit 106).

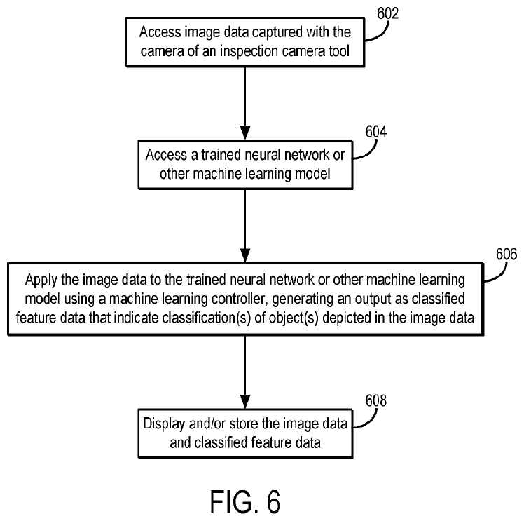

The electronic processor 350 can be configured to communicate with the memory 352 to store data and retrieve stored data. The electronic processor 350 can be configured to receive instructions and data from the memory 352 and execute, among other things, the instructions. In particular, the electronic processor 350 executes instructions stored in the memory 352. Thus, the control hub 132 coupled with the electronic processor 350 and the memory 352 can be configured to perform the methods described herein (e.g., the of FIG. 6, the method of FIG. 8).

The memory 352 can include read-only memory (“ROM”), random access memory (“RAM”), other non-transitory computer-readable media, or a combination thereof. The memory 352 can include instructions for the electronic processor 350 to execute. The instructions can include software executable by the electronic processor 350 to enable the control hub 132 to, among other things, receive data and/or commands, transmit data, control operation of the pipeline inspection tool 102a, the dedicated monitor unit 106, and the like. The software can include, for example, firmware, one or more applications, program data, filters, rules, one or more program modules, and other executable instructions.

The electronic processor 350 is configured to retrieve from memory 352 and execute, among other things, instructions related to the control processes and methods described herein. The electronic processor 350 is also configured to store data on the memory 352 including images and/or video captured with the camera 122, usage data (e.g., usage data of the pipeline inspection tool 102a), feedback data (e.g., user feedback, labeled images, annotated images, etc.), environmental data, operator data, location data, and the like.

The pipeline inspection tool 102a (including the camera 122 and control hub 132) receives electrical power from the power source 134, which in some examples may be a battery pack that can be removably coupled to the pipeline inspection tool 102a, and optionally from a backup power source or an external power source (e.g., a wall outlet). As an example, the power source 134 can be any suitable battery pack used to power the pipeline inspection tool 102a. The battery pack can include one or more battery cells of various chemistries, such as lithium-ion (Li-Ion), nickel cadmium (Ni-Cad), etc. The battery pack may have a nominal voltage of approximately 12 volts (between 8 volts and 16 volts), approximately 18 volts (between 16 volts and 22 volts), approximately 72 volts (between 60 volts and 90 volts), or another suitable amount. In the illustrated example, the battery pack 104 has a nominal voltage of 18 V. The battery pack can further include a pack electronic controller (pack controller) including a processor and a memory. The pack controller can be configured to regulate charging and discharging of the battery cells. In some embodiments, the battery pack can further include an antenna (e.g., a wireless communication device). Accordingly, in some embodiments the pack controller, and thus the battery pack, can be configured to wirelessly communicate with other devices, such as a power tool, a power tool battery charger, other power tool pack adapters, other power tool devices, a cellular tower, a Wi-Fi® router, a mobile device, access points, etc.

In some embodiments, the control hub 132 of the pipeline inspection tool 102a may also include a wireless communication device 354. In these embodiments, the wireless communication device 354 is coupled to the control hub 132 (e.g., via the device communication bus). The wireless communication device 354 may include, for example, a radio transceiver and antenna, a memory, and an electronic processor. In some examples, the wireless communication device 354 can further include a global navigation satellite system (“GNSS”) receiver configured to receive signals from GNSS satellites (e.g., global positioning system (“GPS”) satellites), land-based transmitters, etc. The radio transceiver and antenna operate together to send and receive wireless messages to and from the external device 104, the dedicated monitor unit 106, additional power tool devices, the server 108, and/or the electronic processor of the wireless communication device 354. The memory of the wireless communication device 354 stores instructions to be implemented by the electronic processor and/or may store data related to communications between the pipeline inspection tool 102a and the external device 104, the dedicated monitor unit 106, additional power tool devices, and/or the server 108.

The electronic processor for the wireless communication device 354 controls wireless communications between the pipeline inspection tool 102a and the external device 104, dedicated monitor unit 106, additional power tool devices, and/or the server 108. For example, the electronic processor of the wireless communication device 354 buffers incoming and/or outgoing data (e.g., images, video, classified feature data, usage data, feedback data, other power tool device data), communicates with the electronic processor 350 and determines the communication protocol and/or settings to use in wireless communications.

In some embodiments, the wireless communication device 354 is a Bluetooth ® controller. The Bluetooth® controller communicates with the external device 104, dedicated monitor unit 106, additional power tool devices, and/or the server 108 employing the Bluetooth® protocol. In such embodiments, therefore, the external device 104, dedicated monitor unit 106, additional power tool devices, and/or the server 108 and the pipeline inspection tool 102a are within a communication range (i.e., in proximity) of each other while they exchange data. In other embodiments, the wireless communication device 354 communicates using other protocols (e.g., Wi-Fi®, cellular protocols, a proprietary protocol, etc.) over a different type of wireless network. For example, the wireless communication device 354 may be configured to communicate via Wi-Fi® through a wide area network such as the Internet or a local area network, or to communicate through a piconet (e.g., using infrared or NFC communications). The communication via the wireless communication device 354 may be encrypted to protect the data exchanged between the pipeline inspection tool 102a and the external device 104, dedicated monitor unit 106, additional power tool devices, and/or the server 108 from third parties.

The wireless communication device 354, in some embodiments, exports images, video, classified feature data, usage data, feedback data, and/or other data as described above from the pipeline inspection tool 102a (e.g., from the electronic processor 350 of the control hub 132). The wireless communication device 354 can also enable the pipeline inspection tool 102a to transmit location information (e.g., a sonde message) that helps for location tracking of the locator device 124.

In some embodiments, the control hub 132 may be in wireless communication with both the external device 104 and the dedicated monitor unit 106 simultaneously. For example, the images captured by the camera 122 and/or the classified feature data generated from those images may be simultaneously displayed on the external device 104 and the dedicated monitor unit 106. In some examples, the control hub 132 may only be in wireless communication with one of the dedicated monitor unit 106 or the external device 104 at the same time. For example, the control hub 132 may be configured to automatically decouple from the dedicated monitor unit 106 when a wireless connection is made between the control hub 132 and the external device 104. Likewise, the control hub 132 may be configured to automatically decouple from the external device 104 when a wireless connection is made between the control hub 132 and the dedicated monitor unit 106.

In some embodiments, the control hub 132 of the pipeline inspection tool 102a may include a machine learning controller 170. In these instances, the machine learning controller 170 is coupled to the control hub 132 (e.g., via the device communication bus), and in some embodiments may be selectively coupled such that an activation switch (e.g., mechanical switch, electronic switch, user interface element of the pipeline inspection tool 102a) can selectively switch between an activated state and a deactivated state. When the activation switch is in the activated state, the control hub 132 is in communication with the machine learning controller 170 and transmits input data to the machine learning controller 170 (e.g., images, video) and receives decision outputs from the machine learning controller 170 (e.g., classified feature data). When the activation switch is in the deactivated state, the control hub 132 is not in communication with the machine learning controller 170. In other words, the activation switch selectively enables and disables the machine learning controller 170. Additionally or alternatively, the machine learning controller 170 may be implemented on the external device 104 and/or the dedicated monitor unit 106.

The machine learning controller 170 implements a machine learning program, algorithm, or model. In some implementations, the machine learning controller 170 is configured to construct a model (e.g., building one or more algorithms) based on example inputs, which may be done using supervised learning, unsupervised learning, reinforcement learning, ensemble learning, active learning, transfer learning, or other suitable learning techniques for machine learning programs, algorithms, or models. Additionally or alternatively, the machine learning controller 170 is configured to modify a machine learning program, algorithm, or model; to active and/or deactivate a machine learning program, algorithm, or model; to switch between different machine learning programs, algorithms, or models; and/or to change output thresholds for a machine learning program, algorithms, or model.

The machine learning controller 170 can include a trained machine learning model (e.g., a trained neural network) that analyzes and classifies images and/or video captured by the camera 122. For example, the machine learning controller 170 can implement a computer vision model to identify, detect, classify, and/or categorize objects or regions of objects depicted in the images and/or video captured with the camera 122.

The machine learning controller 170 may be a static machine learning controller, a self-updating machine learning controller, an adjustable machine learning controller, or the like.

The external device 104 can include a display 444, an electronic processor 450, a memory 452, a wireless communication device 454, and optionally a machine learning controller 170. The display 444, the electronic processor 450, the memory 452, the wireless communication device 454, and the machine learning controller 170 can communicate over one or more control buses, data buses, etc., for the interconnection between and communication among the various modules, circuits, and components in the external device 104.

The display 444 is configured to display the images and/or classified feature data. As described above, the classified feature data can be received from the control hub 132, or may be generated by processing images received from the control hub 132 or dedicated monitor unit 106 using the machine learning controller 170 of the external device 104. The display 444 can include a flat panel display, such as a liquid crystal display (“LCD”) panel, an LED display panel, and the like. The flat panel display can be configured to generate characters (e.g., a character display) and/or images. As an example, the flat panel display can be configured to generate images captured by the camera 122. Additionally or alternatively, the flat panel display can be configured to generate characters (e.g., single characters, character strings), such as labels or annotations stored in the classified feature data.

Additionally, the external device 104 may include an application with a graphical user interface (“GUI”) configured to display the images captured by the camera 122 and/or the classified feature data generated by the machine learning controller 170. As noted above, in some examples the external device 104 may implement the machine learning controller 170, such that the external device 104 receives images from the camera 122 (e.g., via the wireless communication device 354 of the control hub 132, via the dedicated monitor unit 106) and processes the images with the machine learning controller 170 to generate the classified feature data. The GUI can also enable the user to provide feedback on the classified feature data displayed by the display 444. For instance, a user an indicate whether the classified feature data accurately represent objects depicted in the images captured by the camera 122, or whether labels, annotations, or the like, in the classified feature data should be revised. These feedback data may be communicated back to the machine learning controller 170 (e.g., whether implemented locally on the external device 104, or to an external machine learning controller 170 via the wireless communication device 454) to retrain or otherwise update the machine learning model implemented by the machine learning controller 170.

The dedicated monitor unit 106 can include a power source 634, display 644, an electronic processor 650, a memory 652, a wireless communication device 654, and optionally a machine learning controller 170. The display 644, the electronic processor 650, the memory 652, the wireless communication device 654, and the machine learning controller 170 can communicate over one or more control buses, data buses, etc., for the interconnection between and communication among the various modules, circuits, and components in the dedicated monitor unit 106.

The display 644 is configured to display the images and/or classified feature data. As described above, the classified feature data can be received from the control hub 132, or may be generated by processing images received from the control hub 132 or dedicated monitor unit 106 using the machine learning controller 170 of the external device 104. The display 644 can include a flat panel display, such as an LCD panel, an LED display panel, and the like. The flat panel display can be configured to generate characters (e.g., a character display) and/or images. As an example, the flat panel display can be configured to generate images captured by the camera 122. Additionally or alternatively, the flat panel display can be configured to generate characters (e.g., single characters, character strings), such as labels or annotations stored in the classified feature data.

Additionally, the dedicated monitor unit 106 may include an application with a GUI configured to display the images captured by the camera 122 and/or the classified feature data generated by the machine learning controller 170. As noted above, in some examples the dedicated monitor unit 106 may implement the machine learning controller 170, such that the dedicated monitor unit 106 receives images from the camera 122 (e.g., via the wireless communication device 354 of the control hub 132, via the external device 104) and processes the images with the machine learning controller 170 to generate the classified feature data. The GUI can also enable the user to provide feedback on the classified feature data displayed by the display 644. For instance, a user an indicate whether the classified feature data accurately represent objects depicted in the images captured by the camera 122, or whether labels, annotations, or the like, in the classified feature data should be revised. These feedback data may be communicated back to the machine learning controller 170 (e.g., whether implemented locally on the dedicated monitor unit 106, or to an external machine learning controller 170 via the wireless communication device 654) to retrain or otherwise update the machine learning model implemented by the machine learning controller 170.

FIG. 5 shows a block diagram of an example inspection camera system 100, in which the inspection camera tool 102 includes a handheld inspection camera tool 102b, such as the one shown in FIG. 3. The inspection camera system 100 includes the handheld inspection camera tool 102b and optionally an external device 104. The handheld inspection camera tool 102b includes a cable 120 to which a camera 122 is coupled, and a power source 134. The handheld inspection camera 102b receives electrical power from the power source 134, which in some examples may be a battery pack that can be removably coupled to the handheld inspection camera tool 102b, and optionally from a backup power source or an external power source (e.g., a wall outlet), similar to the power source 134 described above with respect to the pipeline inspection tool 102a.

In lieu of a control hub, the handheld inspection camera tool 102b can include an electronic processor 250, a memory 252, a wireless communication device 254, and optionally a machine learning controller 170. The electronic processor 250, the memory 252, the wireless communication device 254, and the machine learning controller 170 can communicate over one or more control buses, data buses, etc., for the interconnection between and communication among the various modules, circuits, and components in the handheld inspection camera tool 102b.

As shown in FIG. 3, the handheld inspection camera tool 102b includes a cable 120 and a camera 122 that is coupled to the distal end of the cable 120. As described above, in some examples the cable 120 may also include a locator device 124 coupled to the cable 120 and/or integrated with the camera 122. In some examples, the cable 120 includes both power and data cables that connect (e.g., electrically connect) the camera 122 to the electronic components of the handheld inspection camera tool 102b. As described above, in some examples, the cable 120 may be removably coupled to the housing 140 of the handheld inspection camera tool 102b, such as by a socket sleeve 142. The cable 120 provides power to the camera 122 (e.g., by providing power from the power source 134) and provides data signals (e.g., transmitting images and/or video captured by the camera 122) from the camera 122 to the electronic processor 250 and/or memory 252 of the handheld inspection camera tool 102b.

In operation, the camera 122 and the cable 120 are fed into a pipe, conduit, or other interior space by a user. The camera 122 is directed to the area-of-interest (e.g., obstruction, blockage, etc.) while the camera 122 sends data signals (e.g., images, video) to the electronic processor 250, where the images and/or video may be processed (e.g., processed by the electronic processor 250, sent to the machine learning controller 170 to be processed) and/or transmitted to the external device 104 for processing (e.g., by electronic processor 450, by a machine learning controller 170 local to the external device 104).

As described, in some examples, the camera 122 is configured to capture an image (e.g., a single image) and/or video (e.g., a series of images) of the inside of the pipe, conduit, or other interior space to which the camera 122 has been delivered. The external device 104 can receive the captured image or video and display the image or video on the display 444 for viewing by a user. Additionally, classified feature data may be generated by processing the image or video with the machine learning controller 170 (e.g., whether local to the handheld inspection camera tool 102b or on the external device 104), and the classified feature data may be received by the external device 104 and can be displayed on the display 444 for viewing by the user. Advantageously, the image or video can be processed with the machine learning controller 170 to generate classified feature data that indicate an identified class or category of regions-of-interest in the image or video. For instance, the classified feature data may include labels or annotations of the image or video, which indicate regions of the image or video corresponding to different identified classifications or categories of materials or objects. Accordingly, it may be beneficial to display the classified feature data together with the image or video. In these instances, the interpretation of images displayed to the user is improved, thereby allowing for an improved user experience.

The electronic processor 250 can receive images captured by the camera 122 and send them to the external device 104 (e.g., via the wireless communication device 254) to show the images on the display 444 of the external device 104 for a user to view. In some examples, the electronic processor 250 can generate classified feature data (e.g., by sending the images from the camera 122 to a machine learning controller 170 where the images are processed by the machine learning controller 170 to generate the classified feature data) and send them to the external device 104 to be shown on the display 444 for the user to view. In some embodiments, the images may be displayed concurrently with the classified feature data (e.g., by overlaying the classified feature data on the images). In other examples, the images received by the external device 104 can be processed to generate classified feature data on the external device 104 (e.g., via a machine learning controller 170 of the external device 104).

The electronic processor 250 can be configured to communicate with the memory 252 to store data and retrieve stored data. The electronic processor 250 can be configured to receive instructions and data from the memory 252 and execute, among other things, the instructions. In particular, the electronic processor 250 executes instructions stored in the memory 252. Thus, the electronic processor 250 and the memory 252 can be configured to perform the methods described herein (e.g., the of FIG. 6, the method of FIG. 8).

The memory 252 can include ROM, RAM, other non-transitory computer-readable media, or a combination thereof. The memory 252 can include instructions for the electronic processor 250 to execute. The instructions can include software executable by the electronic processor 250 to enable the electronic processor 250 to, among other things, receive data and/or commands, transmit data, control operation of the handheld inspection camera tool 102b, and the like. The software can include, for example, firmware, one or more applications, program data, filters, rules, one or more program modules, and other executable instructions.

The electronic processor 250 is configured to retrieve from memory 252 and execute, among other things, instructions related to the control processes and methods described herein. The electronic processor 250 is also configured to store data on the memory 252 including images and/or video captured with the camera 122, usage data (e.g., usage data of the handheld inspection camera tool 102b), feedback data (e.g., user feedback, labeled images, annotated images, etc.), environmental data, operator data, location data, and the like.

In some embodiments, the handheld inspection camera tool 102b may also include a wireless communication device 254. In these embodiments, the wireless communication device 254 is coupled to the electronic processor 250 (e.g., via the device communication bus). The wireless communication device 254 may include, for example, a radio transceiver and antenna, a memory, and an electronic processor. In some examples, the wireless communication device 254 can further include a GNSS receiver configured to receive signals from GNSS satellites (e.g., GPS satellites), land-based transmitters, etc. The radio transceiver and antenna operate together to send and receive wireless messages to and from the external device 104, additional power tool devices, the server 108, and/or the electronic processor of the wireless communication device 254. The memory of the wireless communication device 254 stores instructions to be implemented by the electronic processor and/or may store data related to communications between the handheld inspection camera tool 102b and the external device 104, additional power tool devices, and/or the server 108.

The electronic processor for the wireless communication device 254 controls wireless communications between the handheld inspection camera tool 102b and the external device 104, additional power tool devices, and/or the server 108. For example, the electronic processor of the wireless communication device 254 buffers incoming and/or outgoing data (e.g., images, video, classified feature data, usage data, feedback data, other power tool device data), communicates with the electronic processor 250 and determines the communication protocol and/or settings to use in wireless communications.

In some embodiments, the wireless communication device 254 is a Bluetooth® controller. The Bluetooth® controller communicates with the external device 104, additional power tool devices, and/or the server 108 employing the Bluetooth® protocol. In such embodiments, therefore, the external device 104, additional power tool devices, and/or the server 108 and the handheld inspection camera tool 102b are within a communication range (i.e., in proximity) of each other while they exchange data. In other embodiments, the wireless communication device 254 communicates using other protocols (e.g., Wi-Fi®, cellular protocols, a proprietary protocol, etc.) over a different type of wireless network. For example, the wireless communication device 254 may be configured to communicate via Wi-Fi® through a wide area network such as the Internet or a local area network, or to communicate through a piconet (e.g., using infrared or NFC communications). The communication via the wireless communication device 254 may be encrypted to protect the data exchanged between the handheld inspection camera tool 102b and the external device 104, additional power tool devices, and/or the server 108 from third parties.

The wireless communication device 254, in some embodiments, exports images, video, classified feature data, usage data, feedback data, and/or other data as described above from the handheld inspection camera tool 102b (e.g., from the electronic processor 250). The wireless communication device 254 can also enable the handheld inspection camera tool 102b to transmit location information (e.g., a sonde message) that helps for location tracking of the locator device 124.

In some embodiments, the handheld inspection camera tool 102b may include a machine learning controller 170. In these instances, the machine learning controller 170 is coupled to the electronic processor 250 (e.g., via the device communication bus), and in some embodiments may be selectively coupled such that an activation switch (e.g., mechanical switch, electronic switch, user interface element 146 of the handheld inspection camera tool 102b) can selectively switch between an activated state and a deactivated state. When the activation switch is in the activated state, the electronic processor 250 is in communication with the machine learning controller 170 and transmits input data to the machine learning controller 170 (e.g., images, video received from the camera 122) and receives decision outputs from the machine learning controller 170 (e.g., classified feature data). When the activation switch is in the deactivated state, the electronic processor 250 is not in communication with the machine learning controller 170. In other words, the activation switch selectively enables and disables the machine learning controller 170. Additionally or alternatively, the machine learning controller 170 may be implemented on the external device 104, as described above.

The machine learning controller 170 implements a machine learning program, algorithm, or model, as described above in more detail. The machine learning controller 170 can include a trained machine learning model (e.g., a trained neural network) that analyzes and classifies images and/or video captured by the camera 122. For example, the machine learning controller 170 can implement a computer vision model to identify, detect, classify, and/or categorize objects or regions of objects depicted in the images and/or video captured with the camera 122.

The machine learning controller 170 may be a static machine learning controller, a self-updating machine learning controller, an adjustable machine learning controller, or the like.

As described above in more detail with respect to FIG. 4, the external device 104 can include a display 444, an electronic processor 450, a memory 452, a wireless communication device 454, and optionally a machine learning controller 170. The display 444, the electronic processor 450, the memory 452, the wireless communication device 454, and the machine learning controller 170 can communicate over one or more control buses, data buses, etc., for the interconnection between and communication among the various modules, circuits, and components in the external device 104. The display 444 is configured to display the images and/or classified feature data. Additionally, the external device 104 may include an application with a GUI configured to display the images captured by the camera 122 and/or the classified feature data generated by the machine learning controller 170. The GUI can also enable the user to provide feedback on the classified feature data displayed by the display 444.

Referring now to FIG. 6, a flowchart is illustrated as setting forth the steps of an example method for generating classified feature data using a suitably trained neural network or other machine learning algorithm implemented by a machine learning controller 170. As will be described, the neural network or other machine learning algorithm takes image data (e.g., images, video) captured by the camera 122 of an inspection camera tool 102 as input data and generates classified feature data as output data. As an example, the classified feature data can be indicative of labeled or annotated regions of the input image data, such as classifying or categorizing materials or objects depicted in the image data. For instance, the classified feature data can include labels for regions of the image, which correspond to classifications or categorizations of objects or materials depicted in the image. As an example, the classified feature data may include bounding boxes that identify regions in the image that have been classified as containing or otherwise being associated with a particular class (e.g., an obstruction, a material classification of an obstruction, etc.). In these instances, the bounding boxes may also be labeled or otherwise annotated with an indication of the associated classification of the bounding box, a quantitative score (e.g., a confidence score) associated with the classification, or the like. The classified feature data may also include quantitative information, such as confidence scores for the classification of an image region as belonging to a particular class or category.

The method includes accessing image data (e.g., images, video) with an electronic processor (e.g., server electronic processor 150, handheld inspection camera tool electronic processor 250, control hub electronic processor 350, external device electronic processor 450, dedicated monitor unit electronic processor 650), as indicated at step 602. For instance, accessing the image data may include retrieving such data from a memory (e.g., server memory 152, handheld inspection camera tool memory 252, control hub memory 352, external device memory 452, dedicated monitor unit memory 652) or other suitable data storage device or medium. Additionally or alternatively, accessing the image data may include acquiring such data with a camera or other image capture device (e.g., camera 122 of the inspection camera tool 102) and transferring or otherwise communicating the data to the electronic processor, which may be a part of the inspection camera tool 102 (e.g., electronic processor 250, 350), the external device 104 (e.g., electronic processor 450), the dedicated monitor unit (e.g., electronic processor 650), or the like.

A trained neural network (or other suitable machine learning algorithm or computer vision model) is then accessed with the electronic processor (e.g., server electronic processor 150, handheld inspection camera tool electronic processor 250, control hub electronic processor 350, external device electronic processor 450, dedicated monitor unit electronic processor 650) and/or machine learning controller 170, as indicated at step 604. For instance, the trained neural network can be retrieved from a memory (e.g., server memory 152, handheld inspection camera tool memory 252, control hub memory 352, external device memory 452, dedicated monitor unit memory 652) or other suitable data storage device or medium.

In general, the neural network is trained, or has been trained, on training data to identify, detect, classify, and/or categorize objects depicted in images and/or video captured with a camera, such as images and/or video captured with the camera 122 of the inspection camera tool 102. Accessing the trained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; averaging; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs. In an example, the output layer may include, for example, a number of different nodes, where each different node corresponds to a different object classification in the classified feature data. A first node may indicate a first object classification (e.g., rust detected in an image of a pipe or conduit), a second node may indicate a second object classification (e.g., dirt detected in an image of a pipe or conduit), and so on. Additionally, the output layer may include nodes that indicate a confidence score for a particular classification, which can indicate the level of confidence that a particular object in the image has been accurately classified.

The image data are then input to the one or more trained neural networks using the machine learning controller 170, generating output data as classified feature data, as indicated at step 606. As described above, the classified feature data can include labels or annotations that identify the classification or categorization of objects depicted in the image data. The classified feature data may include visual elements to depict the objects depicted in the image data. For instance, the classified feature data may include bounding boxes, color-coded pixels, or other visual indicators to identify objects depicted in the image data and classified in the classified feature data. Additionally or alternatively, the classified feature data can include quantitative information, such as confidence scores corresponding to labels, annotations, or classifications of the image data.

As one non-limiting example, the classified feature data can include labels or annotations indicating damage to a pipe, conduit, or other interior space; a material type of the pipe, conduit, other interior space, or objects within those spaces; an object type for an obstruction or blockage in the pipe, conduit, or other interior space; and so on. For instance, the classified feature data may include labels or annotations associated with damage or material defects, such as cracks, fractures, rust, corrosion, and so on. Additionally or alternatively, the classified feature data may include labels or annotations associated with material types, compositions, or classes, such as the type of metal used in a pipe, conduit, weld, or the like. As another example, the classified feature data may include labels or annotations associated with the classification of an object depicted in the image data, such as whether an obstruction or blockage is present; what a blockage or obstruction is, or what it is composed of, such as dirt, sediment, plant debris, animal debris, corrosion, calcification, rust, etc. ; and so on. The classified feature data may also indicate a region of a work object that is to be worked on (e.g., a damaged region of a pipe or conduit that needs repair, a fastener, a weld, or other surface or object in the pipe, conduit, or other interior space that requires repair, service, or other work).

In some embodiments, the classified feature data may include segmented image data, in which regions of the image that have been classified are segmented relative to the image background. For example, a blockage or obstruction can be identified and segmented from the remainder of the image. In some examples, the segmented region can be masked, color-coded, or otherwise adjusted to increase the visualization of the segmented region relative to the rest of the image.

In still other examples, the classified feature data may include a confidence score. The confidence score can indicate a confidence of a category or classification that has been assigned to a region of the image data. As another example, the classified feature data may indicate the probability for a particular classification (i.e., the probability that the image data include patterns, features, or characteristics indicative of a particular classification).

The classified feature data generated by inputting the image data to the trained neural network(s) can then be displayed to a user, stored for later use or further processing, or both, as indicated at step 608. For instance, in some embodiments, the classified feature data can be displayed to a user via the display 444 of the external device 104. Additionally or alternatively, the classified feature can be displayed to a user via the display 644 of a dedicated monitor unit 106, as described above. The classified feature data can be received by the electronic processor 450 of the external device 104 (e.g., from the machine learning controller 170, whether local to or remote from the external device 104) and displayed on the display 444, or can be received by the electronic processor 650 of the dedicated monitor unit 106 (e.g., from the machine learning controller 170, whether local to or remote from the dedicated monitor unit 106) and displayed on the display 644. Additionally, the image data may also be received by the external device 104 or dedicated monitor unit 106 and displayed on the respective display 444, 644.

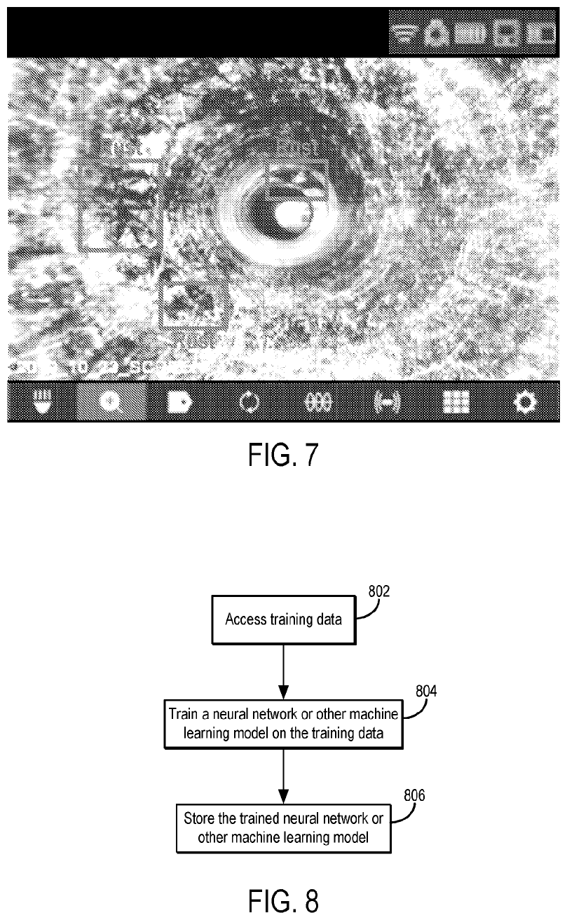

As a non-limiting example, the classified feature data can be overlaid on the image(s) in the image data and presented to the user on the display 444 of the external device 104 or the display 644 of the dedicated monitor unit 106. An example image with overlaid classified feature data is shown in FIG. 7. In this example, the image depicts the interior of a pipe, as captured by the camera 122 of an inspection camera tool 102. The image has been processed by a machine learning controller 170 as described above to generate classified feature data as labels/annotations of regions in the image. In this instance, the classified regions correspond to rust buildup on the interior surface of the pipe. Accordingly, the classified feature data include annotations composed of a bounding box for each identified region and a corresponding label identifying the regions as rust. These annotations are overlaid on the image displayed to the user, so as to provide an improvement in the user's ability to discern what is being viewed by the camera 122 of the inspection camera tool 102.

The classified feature data and/or image data may also be stored for later viewing, processing, or use. For example, the classified feature data can be stored in a memory of the inspection camera tool 102 (e.g., memory 252, 352) by the electronic processor 250, 350, can be stored in a server memory 152 (e.g., by transmitting the classified featured data and/or image data to a server 108), a memory 452 of the external device 104, a memory 652 of the dedicated monitor unit 106, or the like. In some examples, the classified feature data and corresponding image data can be stored for later processing to retrain or otherwise update the training of the neural network(s) or other machine learning algorithm(s) used to generate the classified feature data. In these instances, the classified feature data and corresponding image data can be stored as data pairs for training or retraining the neural network(s) or other machine learning algorithm(s) (e.g., using supervised learning techniques). As described above, in some instances the user can provide feedback on the quality of the classified feature data, and this feedback data can also be stored with the classified feature data and image data to further facilitate retraining or updating the neural network(s) or other machine learning algorithm(s).

In some examples, such as when the image data include video captured with the camera 122 of the inspection camera tool 102, the image data and corresponding classified feature data can track an object depicted in the image data. Advantageously, the same object can be detected, identified, and labeled in subsequent image frames of the video, such that the classified feature data allow for the user to easily track the same object over the duration of the video. These data can be presented to the user in real-time, allowing for the same object to be reliable tracked while the cable 120 and camera 122 are moved about within the interior space to which the inspection camera tool 102 has been introduced.

Referring now to FIG. 8, a flowchart is illustrated as setting forth the steps of an example method for training one or more neural networks (or other suitable machine learning algorithms) on training data, such that the one or more neural networks are trained to receive image data (e.g., images, video) as input data in order to generate classified feature data as output data, where the classified feature data are indicative of classifications or categorizations of regions in the input image data.

In general, the neural network(s) can implement any number of different neural network architectures. For instance, the neural network(s) could implement a convolutional neural network, a residual neural network, or the like. Alternatively, the neural network(s) could be replaced with other suitable machine learning or artificial intelligence algorithms, such as those based on supervised learning, unsupervised learning, deep learning, ensemble learning, dimensionality reduction, and so on.

The method includes accessing training data with a computer system (e.g., an external device 104, a server 108), as indicated at step 802. Accessing the training data may include retrieving such data from a memory or other suitable data storage device or medium, such as the memory 152 of a server 108, the memory 452 of an external device 104, or the like, which may contain a database of annotated images or video. Alternatively, accessing the training data may include acquiring such data with an inspection camera tool 102 and transferring or otherwise communicating the data to the computer system (e.g., an external device 104, a server 108).

In general, the training data can include images or video captured with the camera 122 of an inspection camera tool 102 and annotated by a user. Additionally, the training data may include other data, such as feedback data, usage data, or other power tool device data associated with the inspection camera tool 102 used to capture the images or video. As noted, the training data include images or video that have been labeled (e.g., labeled as containing patterns, features, or characteristics indicative of damage, material defects, material types, object types; and the like).

The method can include assembling training data from images and/or video using a computer system. This step may include assembling the images and/or video into an appropriate data structure on which the neural network or other machine learning algorithm can be trained. Assembling the training data may include assembling image data, segmented image data (e.g., images or video that have been manually segmented or automatically segmented, such as using an image segmentation algorithm or model), and other relevant data (e.g., feedback data, usage data, other power tool device data). For instance, assembling the training data may include generating labeled data and including the labeled data in the training data. Labeled data may include labeled images, labeled image segments (i.e., labeled segmented image data), or other relevant data that have been labeled as belonging to, or otherwise being associated with, one or more different classifications or categories. Additionally, the labeled data may include bounding boxes or other indications of the image regions or segments that have been labeled.

One or more neural networks (or other suitable machine learning algorithms) are trained on the training data using a computer system (e.g., external device 104, server 108), as indicated at step 804. In general, the neural network can be trained by optimizing network parameters (e.g., weights, biases, or both) based on minimizing a loss function. As one non-limiting example, the loss function may be a mean squared error loss function.

Training a neural network may include initializing the neural network, such as by computing, estimating, or otherwise selecting initial network parameters (e.g., weights, biases, or both). During training, an artificial neural network receives the inputs for a training example and generates an output using the bias for each node, and the connections between each node and the corresponding weights. For instance, training data can be input to the initialized neural network, generating output as classified feature data. The artificial neural network then compares the generated output with the actual output of the training example in order to evaluate the quality of the classified feature data. For instance, the classified feature data can be passed to a loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current neural network and its associated network parameters represent the trained neural network. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, unsupervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

The one or more trained neural networks are then stored for later use, as indicated at step 806. Storing the neural network(s) may include storing network parameters (e.g., weights, biases, or both), which have been computed or otherwise estimated by training the neural network(s) on the training data. Storing the trained neural network(s) may also include storing the particular neural network architecture to be implemented. For instance, data pertaining to the layers in the neural network architecture (e.g., number of layers, type of layers, ordering of layers, connections between layers, hyperparameters for layers) may be stored. The neural network can be stored in a memory (e.g., server memory 152, handheld inspection camera tool memory 252, control hub memory 352, external device memory 452, dedicated monitor unit memory 652) to be later accessed by the machine learning controller 170, or in the machine learning controller 170 (e.g., in a memory of the machine learning controller).

Some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates, etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (e.g., hard disks, floppy disks), optical media (e.g., compact discs, digital video discs, Blu-ray discs), semiconductor media (e.g., random access memory (“RAM”), flash memory, electrically programmable read only memory (“EPROM”), electrically erasable programmable read only memory (“EEPROM”)), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (“CD”), digital versatile disk (“DVD”), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (“LAN”). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

The present disclosure has described one or more embodiments, and it should be appreciated that many equivalents, alternatives, variations, and modifications, aside from those expressly stated, are possible.

1. An inspection camera system comprising:
a cable to be directed into an interior space;
a camera disposed on a distal end of the cable and operable to capture an image; and
an electronic processor in communication with the camera, the electronic processor being configured to:
receive the image from the camera;
access a machine learning model that has been trained on training data to generate classified feature data from an input image;
apply the image to the machine learning model to generate classified feature data that indicate a classification of a region in the image; and
display the image and the classified feature data a user.

2. The inspection camera system of claim 1, further comprising a rotatable drum housing the cable.

3. The inspection camera system of claim 2, further comprising a control hub selectively coupled to the drum, wherein the electronic processor is housed within the control hub.

4. The inspection camera system of claim 3, further comprising a monitor unit including a display, the monitor unit being communicatively coupled to the electronic processor, wherein the monitor unit receives the image and the classified feature data from the electronic processor to display the image and the classified feature data on the display.

5. The inspection camera system of claim 1, further comprising a wireless communication device communicatively coupled to the electronic processor, wherein the wireless communication device transmits the image and the classified feature data to an external device having a display to display the image and the classified feature data to the user.

6. (canceled)

7. The inspection camera system of claim 1, further comprising:
a handheld housing, wherein the electronic processor is housed within the handheld housing; and
a display coupled to the handheld housing and communicatively coupled to the electronic processor, wherein the display receives the image and the classified feature data from the electronic processor to display the image and the classified feature data to the user.

8. (canceled)

9. The inspection camera system of claim 1, wherein the machine learning model is a neural network.

10. (canceled)

11. A non-transitory computer-readable storage medium storing instructions thereon that, when executed by one or more processors of an electronic device, cause the one or more processors to perform a method comprising:
receiving an image captured with a camera of an inspection camera tool;
accessing a machine learning model stored in a memory of the electronic device;
inputting the image to the machine learning model to generate classified feature data that indicate a classification of a region in the image; and
display the image and the classified feature data on a display screen.

12. The non-transitory computer-readable storage medium of claim 11, wherein the electronic device is an electronic processor housed within a housing of the inspection camera tool.

13. The non-transitory computer-readable storage medium of claim 12, wherein the image is input to the machine learning model by:
sending the image to an external device having the machine learning model stored thereon;
processing the image by the external device using the machine learning model to generate the classified feature data; and
receiving the classified feature data from the external device.

14. The non-transitory computer-readable storage medium of claim 13, wherein the electronic processor is communicatively coupled to the external device via a wireless communication device.

15. The non-transitory computer-readable storage medium of claim 11, wherein the electronic device is an electronic processor of an external device communicatively coupled to the inspection camera tool.

16. (canceled)

17. A method for processing an image captured with an inspection camera tool, comprising:
(a) capturing an image of an environment using a camera communicatively coupled to a camera inspection tool, wherein the environment comprises an interior space accessed by the camera inspection tool;
(b) receiving the image by an electronic processor;
(c) applying the image to a machine learning controller using the electronic processor, generating as an output classified feature data indicating a classification of a region in the image;
(d) receiving the classified feature data from the machine learning controller by the electronic processor; and
(e) displaying the image and the classified feature data to a user via a display screen communicatively coupled to the electronic processor.

18. (canceled)

19. The method of claim 17, wherein the interior space comprises an interior of a pipe and the classified feature data indicate the presence of an obstruction within the interior of the pipe.

20. The method of claim 19, wherein the classified feature data further indicate a classification of the obstruction within the interior of the pipe.

21. The method of claim 20, wherein the classification of the obstruction includes a classification of a material composition of the obstruction.

22. The method of claim 17, wherein the classified feature data comprise a visual element indicating the region in the image.

23. (canceled)

24. The method of claim 17, wherein the classified feature data indicate a classification of the region in the image as being associated with damage to the interior space.

25. The method of claim 24, wherein the classified feature data indicate the damage to the interior space as one of a crack, a facture, rust, or corrosion.

26. The method of claim 17, wherein the classified feature data indicate a classification of the region in the image as being associated with a material type of the interior space contained in the region in the image.
